(19) United States
(12) Patent Application Publication
(10) Pub. No.: US 2006/0224616 A1
(43) Pub. Date: Oct. 5, 2006

(54) Information processing device and method thereof

(75) Inventors: Kazunori Imoto, Kanagawa (JP); Kohei Momosaki, Kanagawa (JP); Tatsuya Uehara, Tokyo (JP); Manabu Nagao, Tokyo (JP); Yasuyuki Masai, Kanagawa (JP); Munehiko Sasajima, Osaka (JP); Kazuhiko Abe, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/390,395

(22) Filed: Mar. 28, 2006

(30) Foreign Application Priority Data
Mar. 30, 2005 (JP) 2005-100212

(51) Int. Cl. G06F 7/00

(52) U.S. Cl. 707/102

(57) ABSTRACT

An information processing device including a key sound achieving unit 21 for achieving audio data serving as a retrieval key, a designated point achieving unit 51 for achieving as a designated point a time for designating a section of the achieved audio data, a variation point detector 31 for converting the achieved audio data to acoustic feature or image feature parameters and analyzing these feature parameters, and detecting a variation point a time at which variation appears, and a retrieval key generator 41 for determining a retrieval key section on the basis of the variation point and the designated point and recording the portion corresponding to the retrieval key section of the achieved audio data as a retrieval key into a storage medium according to a predefined method.

### CROSS-REFERENCE TO RELATED APPLICATIONS

This application is based upon and claims the benefit of priority from the prior Japanese Patent Application No. 2005-100212, filed on Mar. 30, 2005; the entire contents of which are incorporated herein by reference.

### TECHNICAL FIELD

The present invention relates to an information processing device for retrieving a specific portion from audio data or audio data associated with audio and video data, and a method for the information processing device.

### BACKGROUND OF THE INVENTION

Recently, devices equipped with large-capacity hard discs have been popular as equipment for recording audio data or audio and video data, and a large amount of audio or video content can be accumulated by these devices. Accordingly, users can select their favorable contents from a large amount of contents and view and listen to the contents thus selected.

A method of allocating relevant information (metadata) such as a title or the like for identifying each content on a recording basis is considered as a method of retrieving a target content from a large amount of contents thus accumulated. When a broadcast program is considered as an example, information for identifying a program can be automatically allocated by utilizing program information represented by EPG (Electronic Program Guide), and also a user himself/herself can allocate metal data. By using the metadata thus allocated, a target program can be easily retrieved and viewing/listening and edition of the program can be carried out.

Furthermore, there may be considered such a user's request that a content is divided into minute units (hereinafter referred to as “champers”) which are more minute than the recording unit, and for example a specific program corner is easily retrieved and viewed/listened to. A large amount of labor is needed for a user himself/herself to create metadata which are required for the division into chapter units and the retrieval based on the chapter unit, and also there is little framework to be generally supplied from the external, so that it is required to automatically create metal data from recorded audio and video data or audio data.

A method of using a hiatus such as no-sound or the like, change of pictures called as cut, etc. has been proposed as a method of automatically dividing a program into chapter units. However, the above information does not necessarily appear on a chapter basis like a program corner which is intended by a user, and thus the user is frequently required to carry out manual correction such as deletion of divisional points appearing needlessly, etc. afterwards.

Furthermore, there has been proposed a method of extracting language information such as tickers (telop), words uttered in a program, etc. by a telop recognizing/voice recognizing technique and using the language information thus extracted is used as metadata. According to this method, a scene in which a specific word is uttered can be retrieved by inputting language information which a user wants to retrieve. However, when considering such an application that a program is retrieved and viewed/listened to not only every specific scene, but also every assembly containing a specific scene, it is not easy to implement this application with only language information. Furthermore, the telop recognition/voice recognition needs a large processing amount, and thus it is impossible to robustly perform the telop recognition/voice recognition under the noisy environmentunder the present situation, that is, various problems must be solved to apply this method to audio and video contents (for example, see Japanese Patent No. 3252282).

On the other hand, an audio retrieving method for retrieving a content in consideration of similarity of audio data and a tough audio matching method have been proposed. As compared with a case where language information is extracted as in the case of voice recognition, the robustness is higher, and there are many situations that acoustic retrieval functions effectively, for example, such a situation that a program corner can be divided by utilizing audio data inserted in connection with a program construction. In order to use acoustic retrieval, it is required to register audio data serving as a retrieval key. However, it is a rare case that a retrieval key is prepared in advance, and thus an interface through which a user can easily register a retrieval key is practically important. For example, an interface required to designate the starting and terminating ends of audio data desired to serve as a retrieval key every retrieval is not easy to be handled.

In order to solve this problem, there has been proposed such a method that a user designates any point in an audio data section desired to serve as a retrieval key from accumulated or input audio data, and a fixed section containing a designated point is registered as a retrieval key. However, the length of the retrieval key required is varied in accordance with a retrieving target, and thus an audio section intended by the user cannot be necessarily registered. As a result, there is a case where preceding and subsequent extra audio sections are contained in the retrieval key and thus the retrieval cannot be accurately performed, or conversely there is a case where only a partial section is contained in the retrieval key, and thus an unintended audio section upwells, so that such an unintended audio section is unintentionally retrieved. That is, there is a problem that an accurately retrieval key cannot be necessarily prepared (for example, see Japanese Kokai Patent JP-A-2001-134613;

As described above, it is difficult in the conventional techniques to register a retrieval key for enabling accurate retrieval of a similar portion with a simple operation in acoustic retrieval for retrieving an audio and video content while paying attention to similarity of audio data.

### BRIEF SUMMARY OF THE INVENTION

Therefore, the present invention has been implemented in view of the foregoing situation, and has an object to provide an audio and video processing device for enabling registration of a retrieval key for implementing high-precision acoustic retrieval without accurately designating both of starting and terminating ends.

In order to attain the above object, according to an embodiment of the present invention, an information processing device for retrieving retrieval target audio data or retrieval target audio and video data to be retrieved by a retrieval key comprises: a key audio and video achieving processor unit for achieving key audio and video data for extracting the retrieval key; a key sound extracting processor unit for extracting key audio data from the key audio and video data; an image variation point detecting processor unit for converting image data in the key audio and video data to an image feature parameter and detecting as a variation point a time at which variation of the image feature parameter thus converted appears; and a retrieval key generating processor unit for determining a retrieval key section on the basis of at least one variation point and generating a retrieval key on the basis of the portion corresponding to the retrieval key section in the key audio data.

Furthermore, according to an embodiment of the present invention, an information processing device for retrieving retrieval target audio data or retrieval target audio and video data to be retrieved by a retrieval key comprises: a key audio achieving processor unit for achieving key audio data for extracting the retrieval key; an acoustic variation point detecting processor unit for converting the key audio data to an acoustic feature parameter and detecting as a variation point a time at which variation of the acoustic feature parameter thus converted appears; and a retrieval key generating processor unit for determining a retrieval key section on the basis of at least one variation point and generating a retrieval key on the basis of the portion corresponding to the retrieval key section in the key audio data.

Still furthermore, according to an embodiment of the present invention, an information processing device for retrieving retrieval target audio data or retrieval target audio and video data to be retrieved by a retrieval key comprises: a key audio and video achieving processor unit for achieving key audio and video data for extracting the retrieval key; a key sound extracting processor unit for extracting key audio data from the key audio and video data; an acoustic variation point detecting processor unit for converting the key audio data to an acoustic feature parameter and detecting as a variation point a time at which variation of the acoustic feature parameter thus converted appears; an image variation point detecting processor unit for converting image data in the key audio and video data to an image feature parameter and detecting as a variation point a time at which variation of the image feature parameter thus converted appears; and a retrieval key generating processor unit for determining a retrieval key section on the basis of at least one sound-based variation point or image-based variation point and generating a retrieval key on the basis of the portion corresponding to the retrieval key section in the key audio data.

According to the present invention, a variation point at which an audio or visual cut appears is automatically detected from an audio and visual content to thereby extract an acoustically or visually significant section from the audio and visual content, and a section containing an designating point achieved from a user can be automatically determined as a retrieval key.

Accordingly, the retrieval key can be registered with a simple operation, and also the retrieval key is a section that is acoustically or visually cohesive, so that the acoustic retrieval having high precision can be implemented.

### BRIEF DESCRIPTION FO THE DRAWINGS

FIG. 1 is a diagram showing the construction of an audio and video processing device according to first, second and seventh embodiments of the present invention;

FIG. 2 is a diagram showing an example of audio data achieved by a key sound achieving unit in FIG. 1;

FIG. 3 is a flowchart of the processing of a variation point detector in FIG. 1 according to a first embodiment;

FIG. 4 is a diagram showing an algorithm for judging an audio category in the processing flowchart of FIG. 3;

FIG. 5 is a diagram showing an example of a list of variation points output by the variation point detector in FIG. 1 according to the first embodiment;

FIG. 6 is a flowchart of the processing of a retrieval key generator in FIG. 1 according to the first embodiment;

FIG. 7 is a flowchart of the processing of the variation point detector in FIG. 1 according to a second embodiment;

FIG. 8 is a diagram showing an algorithm for judging an audio category in the processing flowchart of FIG. 7;

FIG. 9 is a diagram showing an example of the list of the variation points output from the variation point detector in FIG. 1 according to the second embodiment;

FIG. 10 is a flowchart of the processing of a retrieval key generator in FIG. 1 according to the second embodiment;

FIG. 11 is a diagram showing the construction of an audio and video processing device according to a third embodiment;

FIG. 12 is a flowchart of the processing of the variation point detector in FIG. 11;

FIG. 13 is a diagram showing the list of variation points output from the variation point detector in FIG. 11;

FIG. 14 is a flowchart of the processing of a retrieval key generator in FIG. 11;

FIG. 15 is a diagram showing the construction of an audio and video processing device according to a fourth embodiment;

FIG. 16 is a diagram showing the construction of an audio and video processing device according to a fifth embodiment;

FIG. 17 is a diagram showing an example of image data achieved by a key picture achieving unit in FIG. 16;

FIG. 18 is a flowchart of the processing of the variation point detector in FIG. 16;

FIG. 19 is a diagram showing an example of the list of variation points output from the variation point detector in FIG. 16;

FIG. 20 is a diagram showing the construction of an audio and video processing device according to a sixth embodiment;

FIG. 21 is a diagram showing an example of image data achieved by a key picture achieving unit in FIG. 20;

FIG. 22 is a diagram showing an example of the list of variation points output from the variation point detector in FIG. 20;

FIG. 23 is a diagram showing an example of audio data achieved by the key sound achieving unit;

FIG. 24 is a flowchart showing the processing of a retrieval key generator in FIG. 1 according to a seventh embodiment;

FIG. 25 is a diagram showing an example of audio data achieved by the key sound achieving unit in FIG. 1 according to a first embodiment; and

FIG. 26 is a diagram showing an example of audio data achieved by the key sound achieving unit in FIG. 1. according to a seventh embodiment

### DETAILED DESCRIPTION FO THE INVENTION

Preferred embodiments according to the present invention will be described hereunder with reference to the accompanying drawings.

In the specification of this application, “audio and video data” are data containing both of video data and audio data. “Video data” are data of only pictures, and “audio data” are data of only sounds such as voices, music, etc.

### First Embodiment

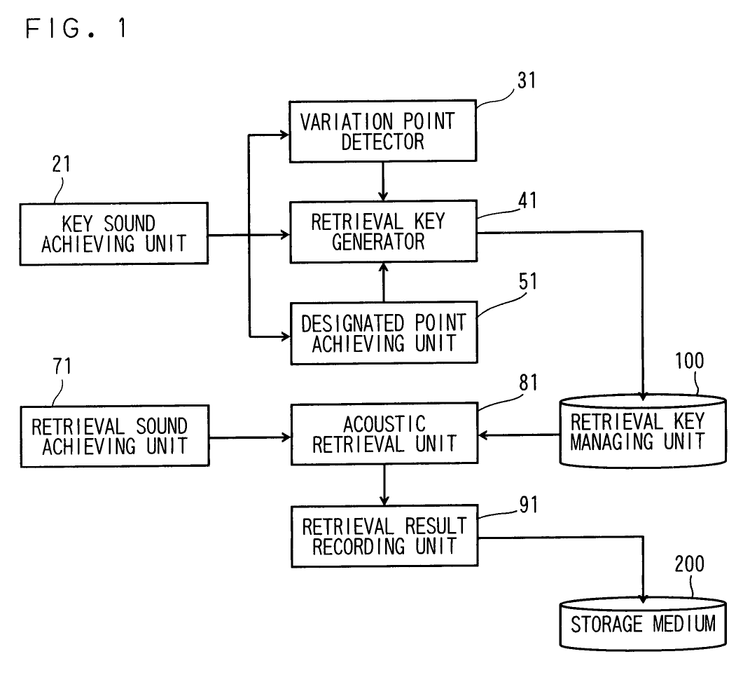

An audio processing device according to a first embodiment will be described with reference to FIGS. 1 to 6 and FIG. 25.

(1) Construction of Audio Processing Device

FIG. 1 is a diagram showing the construction of an audio processing device according to the first embodiment of the present invention.

As shown in FIG. 1, the audio processing device comprises a key sound achieving unit 21, a variation point detector 31, a retrieval key generator 41, a designated point achieving unit 51, a retrieval sound achieving unit 71, an acoustic retrieval unit 81, a retrieval result recording unit 91, a retrieval key managing unit 100 and a recording medium 200.

The key sound achieving unit 21 delivers digital audio data input from an external digital microphone, a reception tuner such as digital broadcast or the like, or other digital equipment to the variation point detector 31, the retrieval key generator 41 and a designated point achieving unit 51. The key sound achieving unit 21 may achieve analog audio signals input from the external microphone, broadcast reception tuner and other equipment, convert the analog audio signals thus achieved to digital audio data by AD conversion, and then deliver the digital audio data to the variation point detector 31, the retrieval key generator 41 and the designated point achieving unit 51. The digital audio data may be recorded in a recording medium 200, and then the variation point detector 31, the retrieval key generator 41 and the designated point achieving unit 51 may read the digital audio data from the recording medium 200. In addition to these processing, deciphering processing, decoding processing, format conversion processing, rate conversion processing, etc. are carried out on audio data as occasion demands.

The variation point detector 31 extracts an acoustic feature parameter from audio data achieved in the key sound achieving unit 21 to detect as a variation point a time at which an acoustic variation appears. The variation point thus detected is delivered to the retrieval key generator 41 as information such as a time or the like with which an access to audio data can be made. The detailed processing of the variation point detector 31 will be described later.

The designated point achieving unit 51 achieves any point contained in a section registered as a retrieval key from audio data achieved in the key sound achieving unit 21 through a user's operation. The user's operation may be carried out by using a device such as a mouse, a remote controller or the like, however, other methods may be used. Furthermore, when a retrieval key is designated, sounds may be reproduced through equipment such as a speaker or the like to designate a point while making a user recognize audio data. The designated point thus detected is delivered to the retrieval key generator 41 as information such as a time or the like with which an access that is accessible to the audio data is possible.

The retrieval key generator 41 identifies a section desired to be registered as a retrieval key by a user on the basis of the variation point detected in the variation point detector 31 and the designated point achieved in the designated point achieving unit 51, converts the portion corresponding to the audio data achieved in the key sound achieving unit 21 to data in a format needed for subsequent acoustic retrieval, and then stores the data thus converted into the retrieval key managing unit 100. The detailed processing of the retrieval key generator 41 will be described later.

The retrieval key managing unit 100 manages retrieval keys registered by users as sound pattern data in such a style that the sound pattern data can be used at the retrieval time. Various embodiments can be implemented as a method of managing the retrieval keys. For example, the retrieval keys can be managed by holding ID for identifying a retrieval key and the audio data of the corresponding section in association with each other. In addition, the overall key audio data may be stored in the storage medium 200 and only the time information of the sections corresponding to the retrieval keys may be held, or they may be converted to acoustic feature parameters used at the retrieval time in the acoustic retrieval unit 81 in advance and held. Furthermore, they may be held while relevant information such as titles of extracted key sounds or the like is associated with the retrieval keys.

The retrieval sound achieving unit 71 delivers digital audio data input from the external microphone, a reception tuner such as digital broadcast or the like or other digital equipment as retrieval target data to the acoustic retrieval unit 81. The retrieval sound achieving unit 71 may achieve analog audio signals input from an external microphone, a broadcast reception tuner or other equipment, convert the analog audio signals to digital audio data by AD conversion and then deliver the audio data to the acoustic retrieval unit 81. This method may be modified so that the digital audio data are recorded in a recording medium 200 and the acoustic retrieval unit 81 reads the digital audio data from the recording medium 200. The difference between the retrieval key achieving unit 21 and the retrieval sound achieving unit 71 resides in only that the take-in sound is used as a retrieval key or a retrieval target. Thus, these unit s may be constructed as a common element.

The acoustic retrieval unit 81 collates the sound data achieved in the retrieval sound achieving unit 71 with one or plural pre-selected sound pattern data out of the sound pattern data managed as retrieval keys in the retrieval key managing unit 100 to detect a coincident or similar section, and outputs the detection result to a retrieval result recording unit 91. Any existing pattern matching method may be used as an algorithm used when the sound data are collated. Furthermore, at the collation time, various algorithms and collation references may be selectively used in accordance with a purpose and, for example, a section having a partial coincidence of sound pattern data serving as a retrieval key or the like is detected.

The retrieval result recording unit 91 achieves the information of a key detected in the acoustic retrieval unit 81 from the retrieval key managing unit 100, and also the information corresponding to the sound pattern data detected is recorded in the recording medium 200 by using the information of the detected section. The information to be recorded has a structure defined in a VR mode of DVD, for example.

(2) Specific Example of Processing

Next, the detailed processing of the audio processing device according to the first embodiment will be described.

(2-1) Processing of Variation Point Detector 31

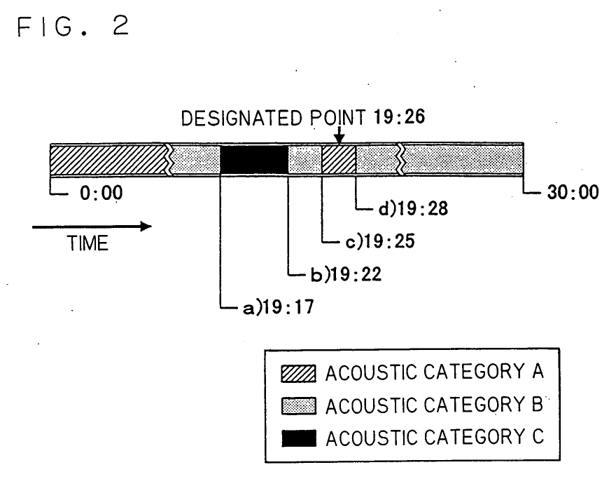

FIG. 2 shows an example of audio data containing a retrieval key. The detailed processing of the variation point detector 31 will be described by considering a case where sounds shown in FIG. 2 are achieved by the key sound achieving unit 21.

Various methods may be considered as a method of detecting variation points. This embodiment uses a method of classifying audio data into any one of predefined acoustic categories such as voice, music, noise sound, etc. and detecting as a variation point a time at which the acoustic category is changed.

(2-1-1) General Processing

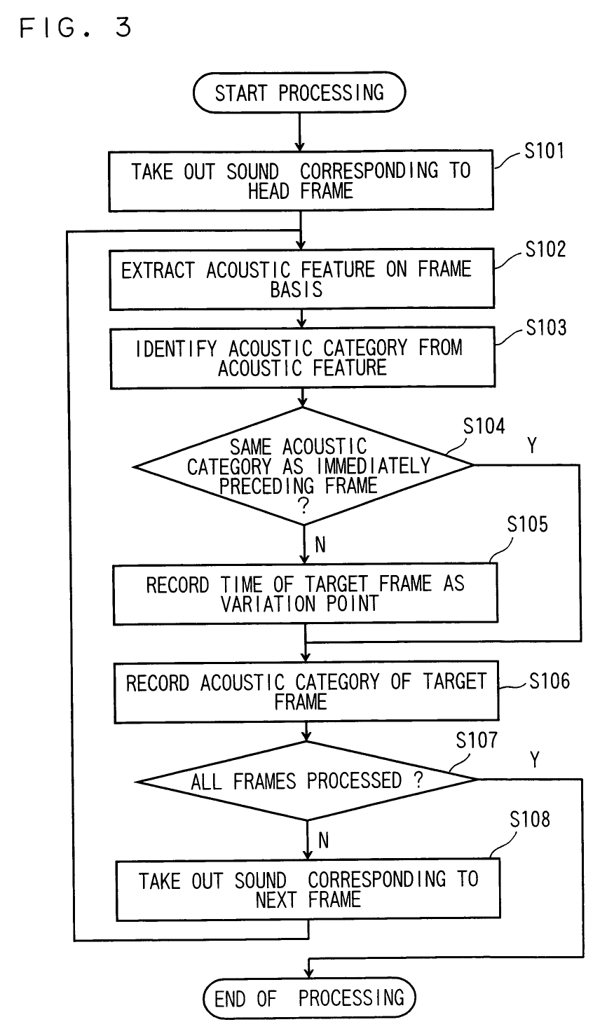

FIG. 3 shows the processing flowchart of the variation point detector 31 of this embodiment.

First, in step S101, audio data corresponding to the head frame section of the retrieval key is achieved. Here, the “frame” represents a detection section having a fixed time width, and in this embodiment the description will be made on the assumption that the frame length is equal to 100 ms, however, any time width may be actually used.

Subsequently, in step S102, an acoustic feature parameter is extracted from the frame audio data extracted in step S101. Various parameters such as the number of zero-crossing, power spectrum, power, pitch, etc. may be considered as the acoustic feature parameter.

In step S103, it is judged on the basis of the extracted acoustic feature parameter to which acoustic category each frame belongs.

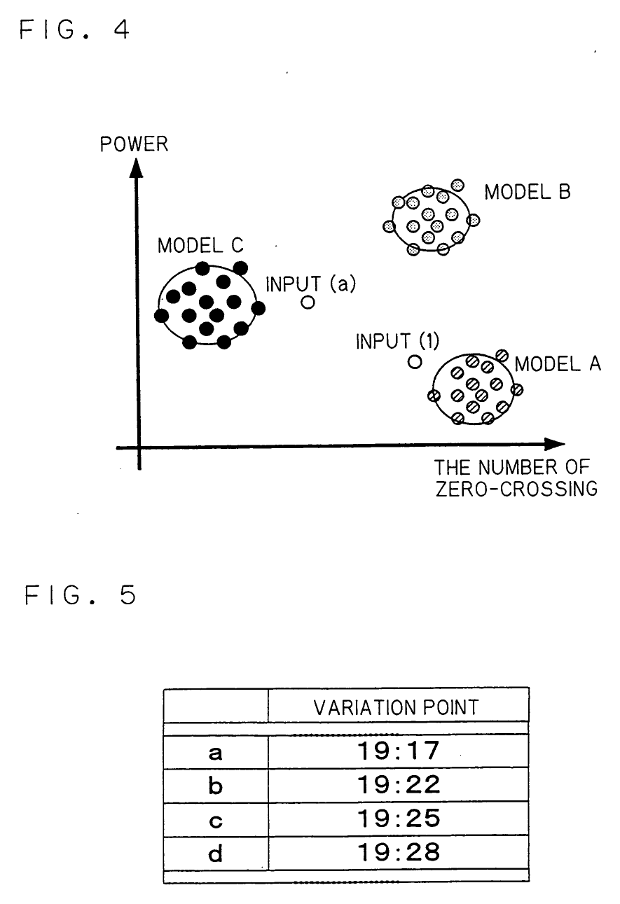

For example, a method of selecting (classifying) an acoustic category in which the distance between the frame and a model learned in advance is shortest may be used as a judgment criterion. FIG. 4 is a diagram showing the judgment criterion for judging the acoustic category. Specifically, FIG. 4 shows a feature space constructed by acoustic feature parameters extracted from each frame. Two feature amounts of the the number of zero-crossing and the power are used, and the feature space is provided while the the number of zero-crossing is plotted on the X axis and the power is plotted on the Y-axis in FIG. 4.

Models A, B, C represented by ellipses correspond to the areas of respective acoustic categories leaned from audio data (corresponding to open circles in FIG. 4) given in advance, and the center of each model is represented by (Xi, Yi). Here, Xi represents the average of the the number of zero-crossing, Yi represents the average of the power and i is a symbol representing each category. An input (1) in FIG. 4 represents the acoustic feature parameters of the head frame to be judged, and they are plotted at (X1, Y1) on the feature space. A method of calculating the distance Si between the input and each model is considered as a criterion for judging a category into which the input (1) is classified.
Si={square root over (((Xi−X1)²+(Yi−Y1)²))}
Here, as Si is smaller, the similarity to the model is enhanced. The distance is calculated for the respective models, and the frame is classified into the category providing the shortest distance. The frame concerned is judged as an acoustic category A on the basis of the distance from each model.

Subsequently, in step S104, an acoustic category to which a target frame belongs is compared with an acoustic category to which the immediately preceding frame belongs, and if these acoustic categories are different from each other, the processing goes to step S105. With respect to the head frame, there is no immediately preceding frame, and thus the processing goes to step S106 as in the case where the coincidence is judged.

In step S106, the acoustic category judged in step S103 is recorded. In this case, the acoustic category A is recorded.

Subsequently, an ending judgment is carried out in step S107. In this case, all the frames have not yet been processed and thus the processing goes to step S108 to take out audio data corresponding to the next frame section. Here, the next frame is set to a section achieved by displacing the head position by a fixed width. The displacing width may be set to any value. For example, the displacing width may be set so that the frames are overlapped with each other or some gap occurs between the neighboring frames.

(2-1-2) Specific Processing

Here is considered a case where the frame of a time a) 19:17 in FIG. 2 is processed after the same processing is repeated. In this case, the immediately preceding frame is assumed to belong to the acoustic category B.

In step S102, the acoustic feature parameters of the target frame are extracted, and the parameters correspond to an input (a) shown in FIG. 4.

Subsequently, in step S103, the distance between the input (a) and the model of each acoustic category is calculated, and the calculation results are compared with respect to the models. In this case, the target frame (input (a)) is classified into the acoustic category C providing the shortest distance. The comparison between the acoustic category of the target frame and the acoustic category of the immediately preceding target is carried out in step S104. In this case, the acoustic categories B and C are different from each other, and thus it is judged that a variation point is detected. Then, the processing goes to step S105.

In step S105, the result that the time a) 19:17 corresponds to the variation point is recorded to enable the subsequent processing to use this result.

Subsequently, in step S106, the acoustic category C to which the present target frame belongs is recorded, and then the processing goes to the ending judgment of the step S107.

When the same processing is carried out on all the key audio data, the ending judgment in step S107 is carried out, a list of variation points as shown in FIG. 5 is output and the processing of the variation point detector 31 is finished.

In this embodiment, the judgment of the acoustic category is carried out by using the acoustic feature parameters extracted from one frame. However, the judgment of the acoustic category may be carried out by using acoustic feature parameters extracted from plural preceding and subsequent frames. Furthermore, with respect to the method of judging the acoustic category, any method suitable for the purpose may be selected, and for example, preceding and subsequent acoustic feature parameters may be directly compared with each other to detect a variation point.

(2-2) Processing of Retrieval Key Generator 41

Subsequently, the detailed processing of the retrieval key generator 41 will be described by using a case where the processing result of the variation point detector 31 to the audio data shown in FIG. 2 is a variation point list shown in FIG. 5.

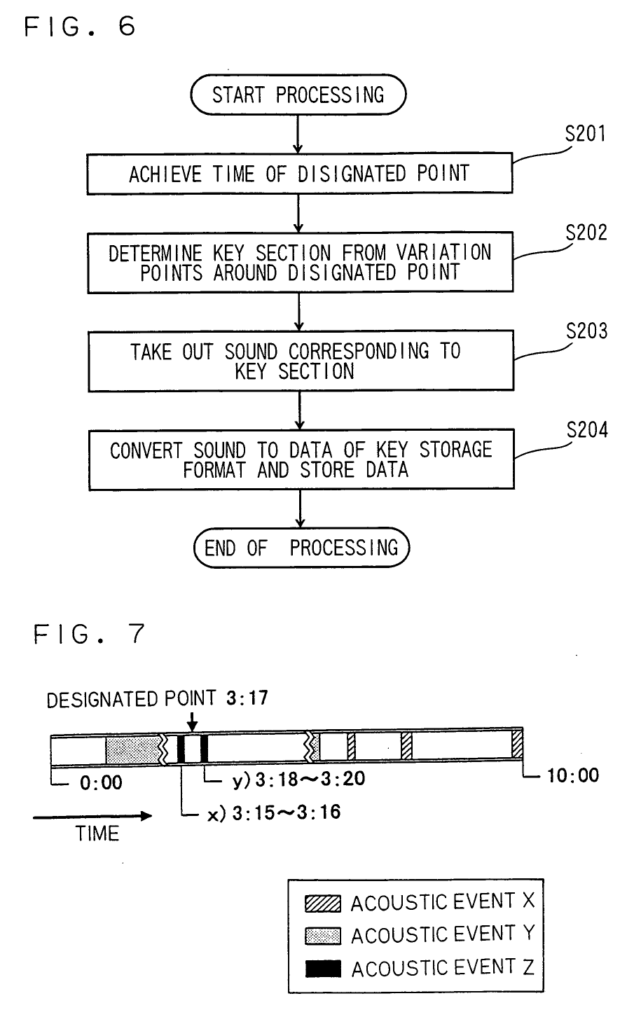

FIG. 6 is a processing flowchart of the retrieval key generator 41 of this embodiment.

Fist, in step S201, a designated point achieved by the designated point achieving unit 51 is achieved in step S201. In this case, 19:26 is achieved as the designated point as shown in FIG. 2.

Subsequently, in step S202 variation points before and after the designated point 19:26 are detected from the list of the variation points. In this case, the variation points (c) 19:25 and (d) 19:28 correspond to the variation points concerned, and thus an area of three seconds surrounded by (c) and (d) is judged as the section of the retrieval key.

Subsequently, after the portion corresponding to the key section is taken out from the audio data achieved by the key sound achieving unit 21 in step S203, the unit concerned is converted to data of a format needed for the acoustic retrieval in step S204, and the data thus converted is delivered to the retrieval key managing unit and then the processing is finished.

Here, the acoustic feature parameters used to carry out the acoustic retrieval may be considered as the format needed for the acoustic retrieval. However, any format may be used insofar as acoustic feature parameters can be reproduced, and for example, audio data itself may be stored if there is an extra capacity in the storage capacity. Furthermore, when the overall key sound is stored in a storage medium, only the section information determined in step S202 may be stored. That is, the format may be implemented by various processing.

It is not easy for a user to accurately designate the section of the retrieval key needed when acoustic retrieval is carried out. According to this embodiment, if any point contained in the retrieval key is designated at least once, an acoustically significant section could be detected and automatically registered as the retrieval key. For example, in a case where an effect sound is required to be registered as a retrieval key, even when any portion of the effect sound is designated, only the portion of the effect sound is automatically registered as a retrieval key. As a result, the user can designate the retrieval key with a very simple operation, and further the retrieval key has an acoustically cohesive section, so that high-precision acoustic retrieval can be implemented.

(3) Modification

In this embodiment, the method of determining a key section with both the ends thereof being free from the variation points before and after the designation point. However, any method may be used insofar as a key section can be determined on the basis of a designation point and variation points.

For example, there may be considered various methods such as a key section determining method of a starting end fixed and terminating end free type for fixing a designation point achieved through user's operation as a starting end and determining a terminating end from variation points appearing subsequently, a key section determining method of a starting end free and terminating end fixed type for determining a terminating end from a designation point, etc.

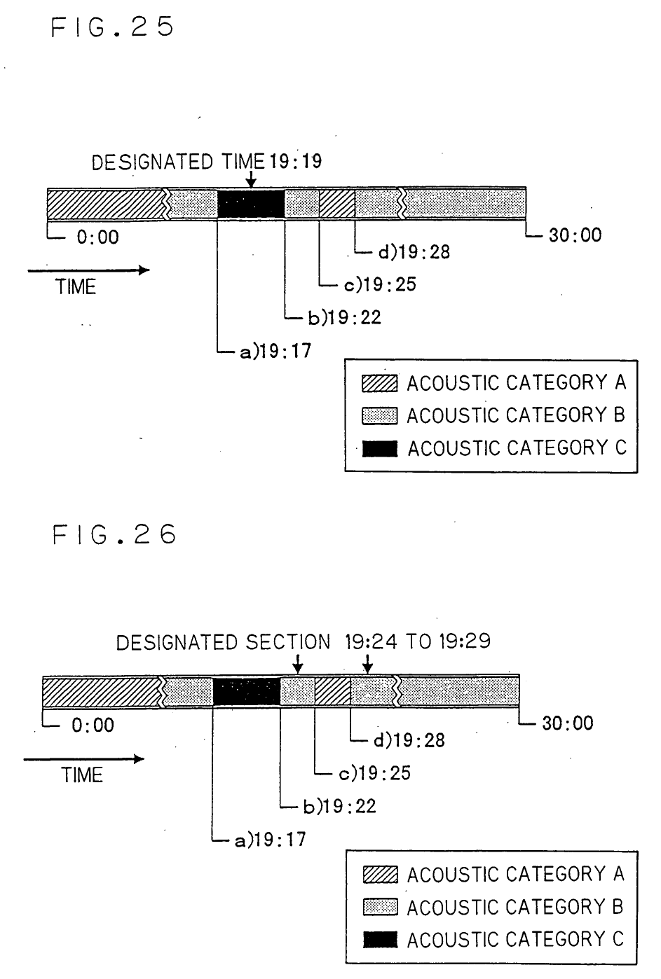

When a key section is determined from audio data shown in FIG. 25 according to the method of the starting end free and terminating end fixed type, the terminating end becomes 19:19 of the designation point, and the starting end becomes the variation point a) 19:22 appearing before the designation point. According to the one-end fixed key retrieval as described above, when a long section is classified into the same acoustic category, the retrieval can be performed by using only the head section or only the last section as a key. In addition, as compared with the case where the section is determined with both the ends being free, various key registration can be performed without increasing the user's operation.

### Second Embodiment

Next, an acoustic processing device according to a second embodiment will be described with reference to FIGS. 7 to 10.

This embodiment is different from the first embodiment in only the processing of the variation point detector 31, and the construction thereof is the same as the first embodiment.

The detailed processing of this embodiment will be described.

FIG. 7 shows an example of audio data containing a retrieval key. The detailed processing of the variation point detector 31 will be described on the basis of a case where sounds shown in FIG. 7 are achieved by the key sound achieving unit 21.

There may be considered various methods of detecting variation points, however, this embodiment uses a method of defining acoustic events serving as acoustic breakpoints in advance, and detecting as a variation point a time at which a defined acoustic even is detected from audio data.

(1) General Processing

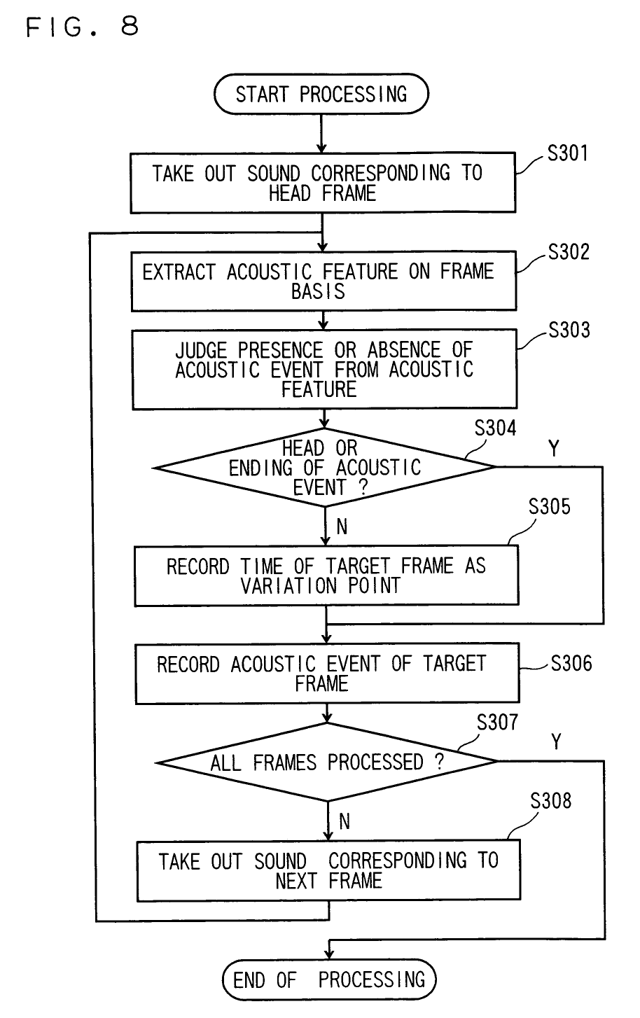

FIG. 8 is a processing flowchart of the variation point detector 31 according to this embodiment.

First, in step S301, the sound corresponding to the head frame section of the retrieval key is achieved.

Subsequently, in step S302, an acoustic feature parameter is extracted from the frame audio data extracted in step S301. As in the case of the first embodiment, various parameters such as the number of zero-crossing, power spectrum, power, pitch, etc. may be considered as the acoustic feature parameter.

In step S303, it is judged by using the acoustic feature parameter extracted at the preceding stage whether a pre-defined acoustic even occurs in the section corresponding to the frame.

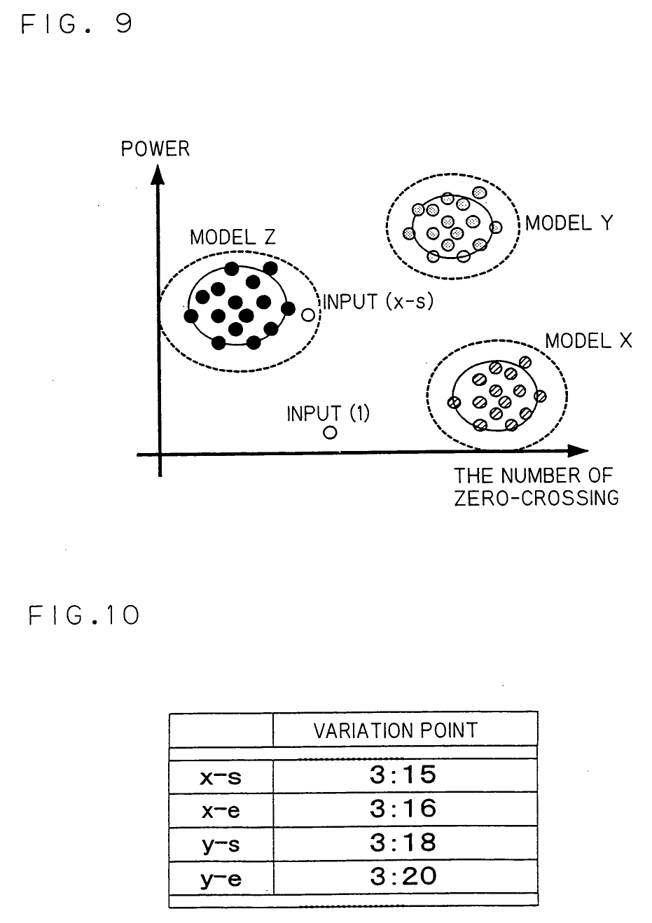

As a judgment criterion, if there is any acoustic event whose distance from a model learned in advance is within a threshold value, it is judged that the event concerned occurs. FIG. 9 is a diagram showing the criterion for judging the occurrence of the acoustic event.

FIG. 9 represents a feature space constructed by acoustic feature parameters extracted from a frame. In this case, the two feature amounts of the number of zero-crossing and power are used as the acoustic feature parameters, and the feature space is provided while the the number of zero-crossing is plotted on the X axis and the power is plotted on the Y axis. Models X and y represented by ellipses correspond to the areas of acoustic events learned from audio data (corresponding to open circles in FIG. 9) given in advance, and the center of each acoustic event is represented by (Xi, yi), respectively. Here, Xi represents the average of the the number of zero-crossing, Yi represents the average of the power, and i is a symbol representing each category. Furthermore, a broken line surrounding each model corresponds to a threshold value Ti for judging the occurrence of each acoustic event. An input (1) in FIG. 9 represents an acoustic feature parameter of a frame to be judged, and it is assumed to be plotted at (X1, Y1) on the feature space. A criterion for judging whether an even occurs at the input (1) may be a judgment as to whether the distance Si between each model and the input is not more than the threshold value Ti.
Si={square root over (((Xi−X1)²+(Yi−y1)²))}<Ti

At the input (1), there is no event whose the distance from each model is within the threshold value, and thus it is judged that no acoustic event occurs in this frame.

In step S304, a judgment as to the head or ending of the acoustic event in the target frame is made. If the condition is satisfied, the processing goes to step S305. With respect to the head frame, no acoustic event occurs and thus the processing goes to step S306.

In step S306, the acoustic event judged in step S303 is recorded. In this case, no acoustic event is detected and thus nothing is recorded.

Subsequently, in step S307, the ending judgment is carried out. In this case, all the frames have not yet been processed, and thus the processing goes to step S308 to take out audio data corresponding to the next frame section.

(2) Specific Processing

There is assumed a case where a frame containing the start time of X) 3:15 of FIG. 9 (the head and ending of the event are represented by affixing suffixes -s and -e respectively) has been processed after the same processing is repeated. Here, no acoustic event is detected in the immediately preceding frame.

In step S302, the acoustic feature parameters of the target frame are extracted, and the parameters correspond to an input (X-s) shown in FIG. 9.

Subsequently, in step S303, it is judged whether the acoustic feature parameters are within the threshold value of the model of each acoustic event, and it is judged that an acoustic event Z occurs in the target frame. Since no event occurs in the immediately preceding frame in the judgment carried out in step 304, it is judged as the start point of the acoustic event and then the processing goes to step S305.

In step S305, the judgment result that the time X-s) 3:15 is a variation point is recorded to be usable in the subsequent processing.

Subsequently, the acoustic event Z detected in the present target frame is recorded in step S306, and then the processing goes to an ending judgment of step S307.

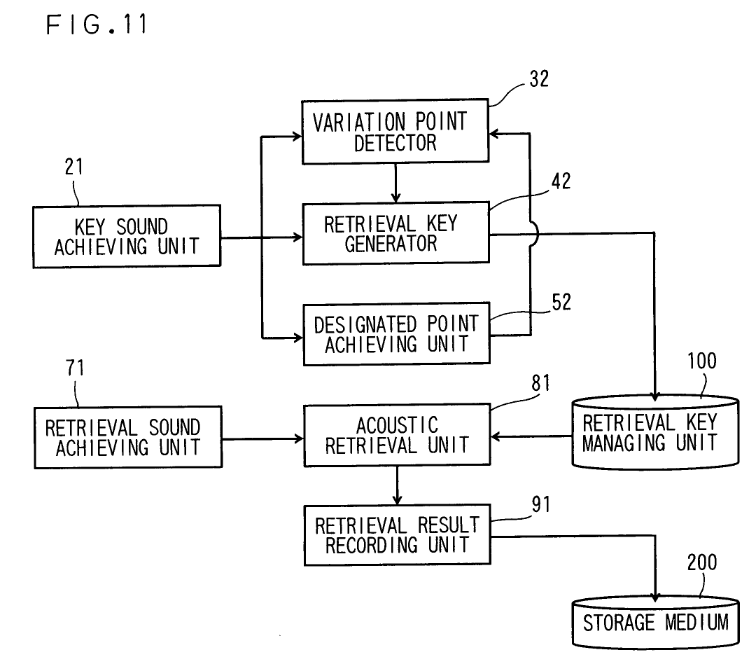

When the same processing is carried out on all the key audio data, the ending judgment is carried out in step S307, and a list of variation points as shown in FIG. 10 is output and the processing of the variation point detector 31 is finished.

This embodiment is different from the first embodiment in that in place of the method of classifying all the sections of the key audio data into any acoustic category, only a pre-defined acoustic event is detected and the head/ending point is detected as a variation point. For example, no-sound is registered as an acoustic event, whereby a sound section surrounded by no-sound areas can be registered as a retrieval key.

### Third Embodiment

Next, an audio processing device according to a third embodiment of the present invention will be described with reference to FIGS. 11 to 14.

(1) Construction of Audio Processing Device

FIG. 11 is a diagram showing the construction of an audio processing device according to a third embodiment.

As shown in FIG. 11, the audio processing device comprises a key sound achieving unit 21, an variation point detector 32, a retrieval key generator 42, a designated point achieving unit 52, a retrieving sound achieving unit 71, an acoustic retrieval unit 81, a retrieval result recording unit 91, a retrieval key managing unit 100 and a storage medium 200. In FIG. 1, the elements carrying out the same processing as the embodiments described above are represented by the same reference numerals, and the description thereof is omitted.

Through user's operation, the designated point achieving unit 52 achieves any point contained in a section required to be registered as a retrieval key from audio data achieved by the key sound achieving unit 21. The designated point thus detected is delivered to the variation point detector 32 as information such as a time or the like with which an access to the audio data is possible.

The variation point detector 32 extracts the acoustic feature parameters from the audio data achieved in the key sound achieving unit 21, and detects as a variation point a time at which an acoustic variation appears. This embodiment is different from the first embodiment in that by using the designation point achieved in the designation point achieving unit 52 when the variation point is detected, only the requisite minimum variation point is detected. The variation point thus detected is delivered to the retrieval key generator 42 as information such as a time or the like with which an access to the audio data is possible. The detailed processing of the variation point detector 32 will be described later.

The retrieval key generator 42 identifies from the variation point detected in the variation point detector 31 a section which is required as a retrieval key by a user, converts the portion corresponding to the audio data achieved in the key sound achieving unit 21 to data of a format required for the subsequent acoustic retrieval, and stores the data thus converted into the retrieval key managing unit 100. The detailed processing of the retrieval key generator 42 will be described later.

(2) Processing of Acoustic Processing Device

Next, the detailed processing of the audio processing device according to the third embodiment will be described by using a specific example.

(2-1) Processing of Variation Point Detector 32

The detailed processing of the variation point detector 32 will be described by using a case where sounds shown in FIG. 2 are achieved by the key sound achieving unit 21.

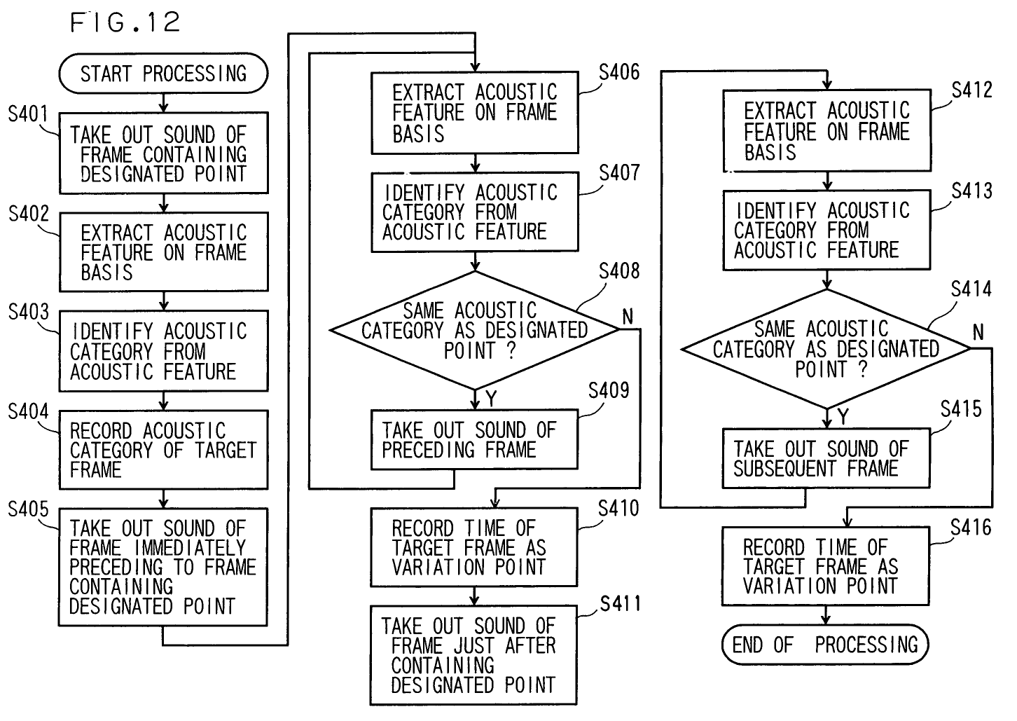

The description will be made by using the same variation point detecting method as the first embodiment. FIG. 12 is a processing flowchart of the variation point detector 32 according to this embodiment.

First, in step S401, the sound corresponding to a frame section containing a designation point is achieved.

In step S402, acoustic feature parameters are extracted from the frame audio data extracted in step S401.

In step S403, it is judged by using the extracted acoustic feature parameters to which acoustic category each frame belongs. In the case of FIG. 2, the frame containing the designated point is judged to belong the acoustic category A, and the acoustic category A detected in step S404 is recorded.

Subsequently, in step S405, the sound corresponding to the immediately preceding frame section is achieved. As in the case of steps S402 and S403, the acoustic feature parameters of the target frame are extracted in step S406, and an acoustic category to which the target frame belongs is judged on the basis of the acoustic feature parameters in S407.

In step S408, it is judged whether the acoustic category of the target frame is coincident with the acoustic category of the frame containing the designated point. Only when both the acoustic categories are coincident with each other, the sound corresponding to the immediately preceding frame is taken out in step S409, and the processing from the step S406 to the step S409 is repeated.

In the case of FIG. 2, the acoustic category A is judged until the frame containing a time c) 19:25, and thus the processing is repeated. When the acoustic category of the next frame is judged as the acoustic category B in step S407, the processing goes to step S410 to record the time c) 19:25 of the target frame as a variation point.

Subsequently, the sound corresponding to the just subsequent frame section to the frame containing the designated point is achieved in step S411.

As in the case of the step S402 and the step S403, the acoustic feature parameters of the target frame are extracted in step S412, and the acoustic category to which the frame concerned belongs is judged on the basis of the acoustic feature parameters in step S413.

In step S413, it is judged whether the acoustic category of the target frame is coincident with the acoustic category of the frame containing the designated point, and only when both the acoustic categories are coincident with each other, the sound corresponding to the immediately subsequent frame is taken out in step S415, and the processing from the step S412 to the step S415 is repeated.

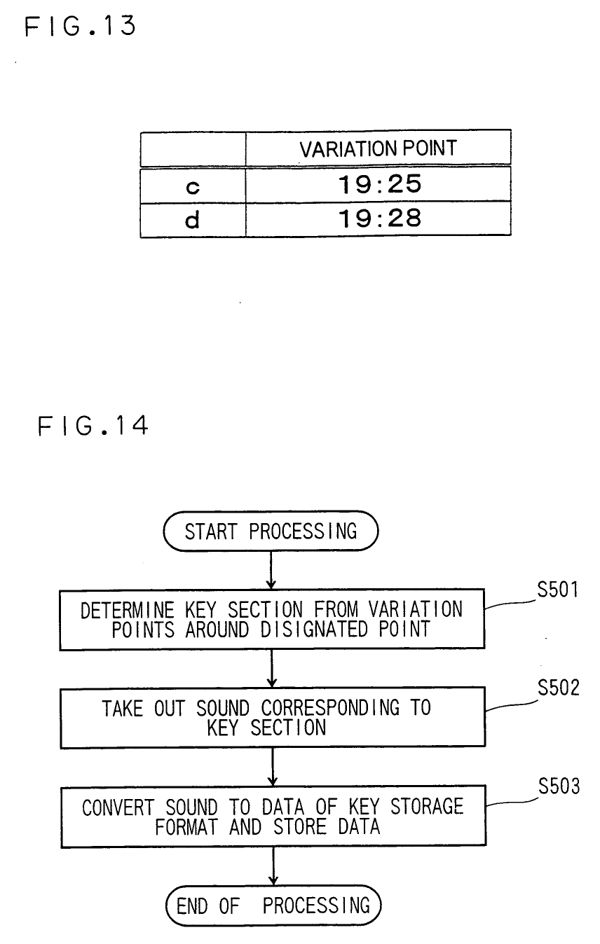

In the case of FIG. 2, since the acoustic category A is judged until the frame containing a timed) 19:28, the processing is repeated. When the acoustic category of the next frame is judged as the acoustic category B in step S407, the processing goes to step S416, and the time d) 19:28 of the target frame is recorded as a variation point. A list of variation points as shown in FIG. 13 is output and then the processing of the variation point detector 31 is finished.

In this embodiment, only the variation points before and after the designated point are extracted, and thus the number of frames to be processed is small, and also the section of the retrieval key can be determined from only the list of the variation points.

(2-2) Processing of Retrieval Key Generator 42

Subsequently, the detailed processing of the retrieval key generator 42 will be described by using a case where the processing result of the variation point detector 31 to the audio data shown in FIG. 2 corresponds to a list of variation points shown in FIG. 13.

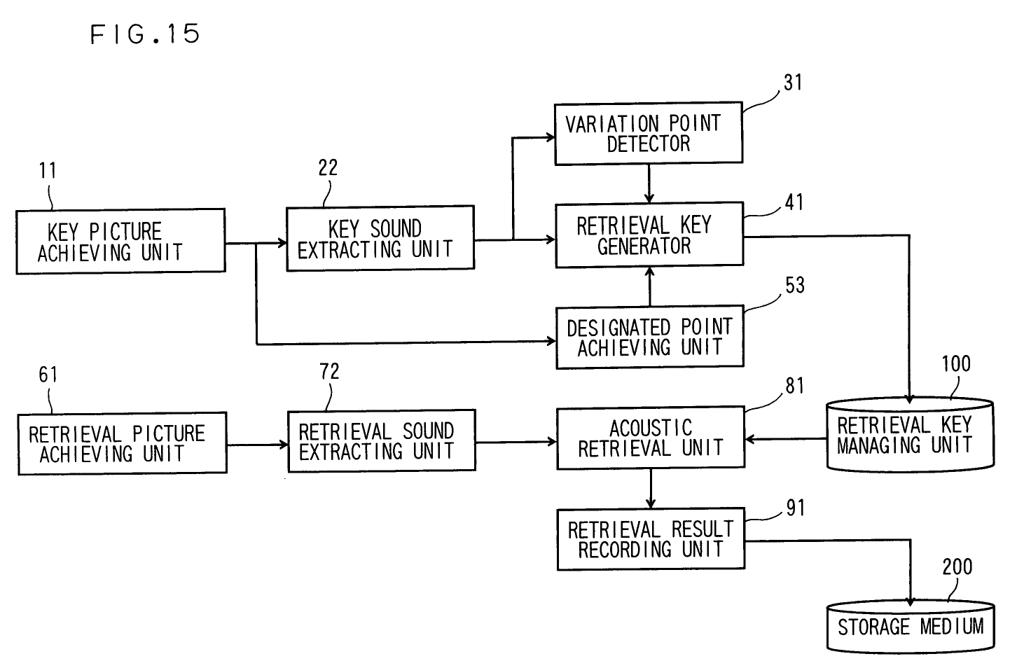

FIG. 14 is a processing flowchart of the retrieval key generator 42 of this embodiment.

First, in step S501, variation points are achieved and the section of the retrieval key is determined. In this case, (c)19:25 and (d) 19:28 are the variation points, and thus a section of three seconds surrounded by (c) and (d) is judged as the section of the retrieval key.

Subsequently, the portion corresponding to the key section is taken out from the audio data achieved by the key sound achieving unit 21 in step S502 and converted to data of a format needed for acoustic retrieval in step S503. Thereafter, the data thus converted are delivered to the retrieval key managing unit 100 and then the processing is finished.

By supplying the time information of the designated point to the variation point detector 32 as in the case of this embodiment, the processing amount needed to detect variation points is reduced, so that the time required from the time when the designated point is achieved through user's operation until the time when the section of the retrieval key is detected and automatic registration is carried out can be shortened.

### Fourth Embodiment

Next, a fourth embodiment of the present invention will be described with reference to FIG. 15.

FIG. 15 is a diagram showing the construction of an audio and video processing device according to a fourth embodiment.

As shown in FIG. 15, the audio and video processing device of this embodiment comprises a key picture achieving unit 11, a key sound extracting unit 22, a variation point detector 31, a retrieval key generator 41, a designated point achieving unit 53, a retrieval picture achieving unit 61, a retrieval sound extracting unit 72, an acoustic retrieval unit 81, a retrieval result recording unit 91, a retrieval key managing unit 100 and a storage medium 200. In FIG. 15, the elements carrying out the same processing as the above-described embodiments are represented by the same reference numerals, and the description thereof is omitted. This embodiment is greatly different from the above-described embodiments in that audio and video data are handled.

The key picture achieving unit 11 achieves audio and video data input from an external digital video camera, a reception tuner of digital broadcast or the like or other digital equipment, and delivers the audio and video data to the key sound extracting unit 22 and the designated point achieving unit 53. The key picture achieving unit 11 may achieve audio and video data input from the external video camera, a broadcast reception tuber or other equipment, convert the audio and video data to digital audio and video data and then deliver the digital audio and video data to the key sound extracting unit 22 and the designated point achieving unit 53. The above embodiment may be modified so that the digital audio and video data are recorded in the recording medium and the key sound extracting unit 22 and the designated point achieving unit 53 read the digital audio and video data from the recording medium 200. In addition to these processing, deciphering processing (for example, B-CAS) of audio and video data, decoding processing (for example, MPEG2), format conversion processing (for example, TS/PS), rate (compression rate) conversion processing or the like may be carried out as occasion demands.

The key sound extracting unit 22 extracts audio data from the audio and video data achieved in the key picture achieving unit 11, and delivers the audio data thus extracted to the variation point detector 31 and the retrieval key generator 41.

The designated point achieving unit 53 achieves any point contained in a section required to be registered as a retrieval key from the audio and video data achieved in the key picture achieving unit 11 by user's operation. A device such as a mouse, a remote controller or the like may be used for the user's operation, however, other methods may be used. When a retrieval key is designated, it may be reproduced through equipment such as display or the like, so that a user is promoted to designate the retrieval key while recognizing the audio and video data. The designated point thus detected is delivered to the retrieval key generator 41 as information such as a time or the like with which an access to the audio and video data is possible.

The variation point detector 31 extracts acoustic feature parameters from the audio data achieved in the key sound extracting unit 22, and detects as a variation point a time at which an acoustic variation appears. The variation detector point thus detected is delivered to the retrieval key generator 41 as information such as a time or the like with which an access to the audio data is possible.

The retrieval key generator 41 identifies a section required to be registered as a retrieval key by a user on the basis of the variation points detected in the variation point detector 31 and the designated point achieved in the designated point achieving unit 53, converts the portion corresponding to the audio data achieved in the key sound achieving unit 21 to data of a format needed for subsequent acoustic retrieval and then stores the data thus converted into the retrieval key managing unit 100.

The retrieval key managing unit 100 manages the retrieval key registered by the user as sound pattern data in such a format that the data are usable at the retrieval time. Various methods may be used to manage the retrieval key. For example, the retrieval key can be managed by holding ID for identifying the retrieval key and by being associated with the audio data of the corresponding section. Alternatively, the overall key audio data or the overall key video data may be held in the storage medium 200, and only the time information of the section corresponding to the retrieval key may be held, or the retrieval key may be held while converted to acoustic feature parameters used in the acoustic retrieval unit 81 at the retrieval time in advance. Furthermore, as occasion demands, relevant information such as the title of the key audio and video data from which the retrieval key is extracted, etc. may be held in association with the retrieval key.

The retrieval picture achieving unit 61 achieves audio and video data input from an external digital video camera, a reception tuner of digital broadcast or the like or other digital equipment, and delivers the data thus achieved as audio and video data to be retrieved to the retrieval sound extracting unit 72. The retrieval picture achieving unit 61 may achieve audio and video data input from the external video camera, broadcast reception tuner or other equipment, convert the data thus achieved to digital audio and video data and then deliver the digital audio and video data thus converted to the retrieval sound extracting unit 72 as audio and video data to be retrieved. The digital audio and video data may be recorded in the recording medium 200 so that the retrieval sound extracting unit 72 can read the digital audio and video data from the recording medium 200. In addition to these processing, the audio and video data may be subjected to decipher processing (for example, B-CAS), decode processing (for example, MPEG2), format conversion processing (for example, TS/PS), rate (compression rate) conversion processing or the like as occasion demands. The difference between the key picture achieving unit 11 and the retrieval picture achieving unit 61 resides in only that the take-in audio and video data are used as a retrieval key or a retrieval target, and thus these units may be constructed as a common constituent element.

The retrieving sound extracting unit 72 extracts audio data from the audio and video data achieved in the retrieval picture achieving unit 61 and delivers the audio data thus extracted to the acoustic retrieval unit 81. The difference between the key sound extracting unit 22 and the retrieval sound extracting unit 72 resides in only that the extracted audio data is used as a retrieval key or a retrieval target, and thus this unit may be constructed as a common element.

The acoustic retrieval unit 81 collates the audio data achieved in the retrieval sound extracting unit 72 with one or plural sound pattern data pre-selected from the sound pattern data managed as retrieval keys in the retrieval key managing unit 100 to detect a similar section, and outputs the section concerned to the retrieval result recording unit 91. Any existing pattern matching method may be used as an algorithm used when audio data are collated. Furthermore, various algorithms and collating criterions may be selectively used in accordance with the purpose, and for example, a section in which sound pattern data serving as a retrieval key is partially coincident is also detected.

The retrieval result recording unit 91 achieves he information of the key detected in the acoustic retrieving unit 81 from the retrieval key managing unit 100, and also records the information corresponding to the detected sound pattern data in the recording medium 200 by using the information of the detected section. The information to be recorded has a structure defined in the VR mode of the DVD, for example.

By the above construction, the user can designate a retrieval key for audio and video data with a very simple operation as in the case of audio data, and further the retrieval key is an acoustically cohesive section, so that high-precision acoustic retrieval can be implemented.

### Fifth Embodiment

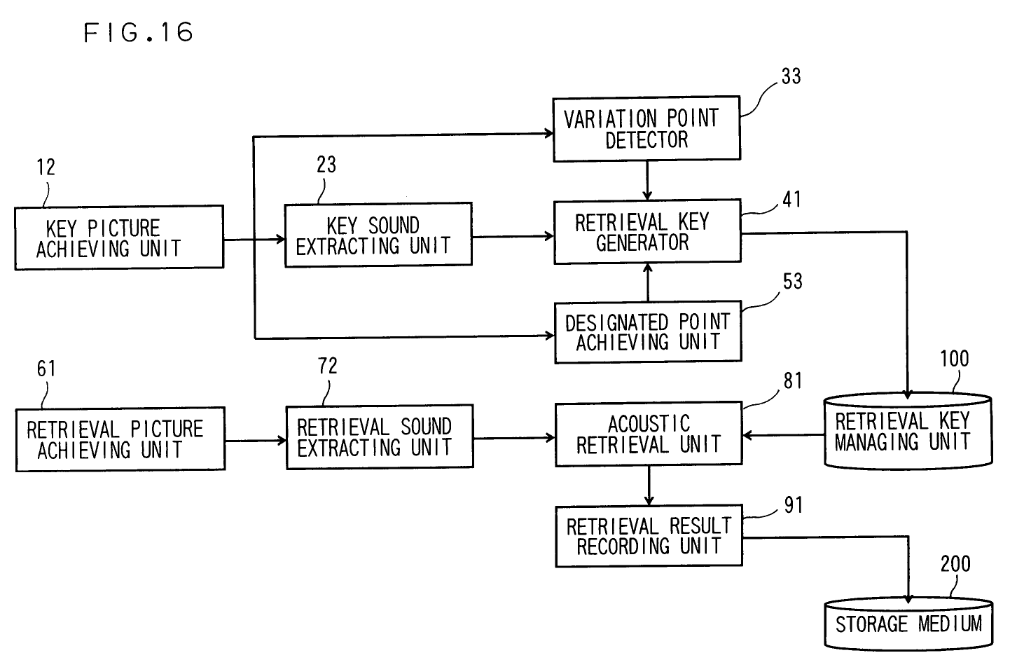

Next, a fifth embodiment will be described with reference to FIGS. 16 to 19.

(1) Construction of Audio and Video Processing Device

FIG. 16 is a diagram showing the construction of an audio and video processing device according to a fifth embodiment.

As shown in FIG. 16, the audio and video processing device comprises a key picture achieving unit 12, a key sound extracting unit 23, a variation point detector 33, a retrieval key generator 41, a designated point achieving unit 53, a retrieval picture achieving unit 61, a retrieval sound extracting unit 72, an acoustic retrieval unit 81, a retrieval result recording unit 91, a retrieval key managing unit 100, and a storage medium 200. In FIG. 16, the elements for carrying out the same processing as the above-described embodiments are represented by the same reference numerals, and the description thereof is omitted. This embodiment is different from the above-described embodiments in that variation points are detected from video data in the variation point detector 33.

The key picture achieving unit 12 achieves audio and video data input from an external digital video camera, a reception tuber of digital broadcast or the like or other digital equipment, and delivers the digital audio and video data to the key sound extracting unit 23, the variation point detector 33 and the designated point achieving unit 53. The key picture achieving unit 11 may achieve audio and video data input from the external video camera, broadcast reception tuber or other equipment, converts the audio and video data to digital audio and video data and then delivers the digital audio and video data to the key sound extracting unit 23, the variation point detector 33 and the designated point achieving unit 53. Alternatively, the digital audio and video data may be recorded in the recording medium 200 so that the key sound extracting unit 23, the variation point detector 33 and the designated point achieving unit 53 can read the digital audio and video signal from the recording medium 200. In addition to these processing, the audio and video data may be subjected to decipher processing (for example, B-CAS), decode processing (for example, MPEG2), format conversion processing (for example, TS/PS), rate (compression rate) conversion processing or the like as occasion demands.

The key sound extracting unit 23 extracts audio data form the audio and video data achieved in the key picture achieving unit 11, and delivers the audio data thus extracted to the retrieval key generator 41.

The variation point detector 33 extracts image feature parameters from the audio and video data achieved in the key picture achieving unit 12, and detects as a variation time a time at which a visual variation appears. The variation point thus detected is delivered to the retrieval key generator 41 as information such as a time or the like with which an access to the audio and video data is possible. The detailed processing of the variation point detector 33 will be described later.

(2) Processing of Audio and Video Processing Device

Next, the detailed processing of the audio and video processing device according to the fifth embodiment will be described.

(2-1) Processing of Variation Point Detector 33

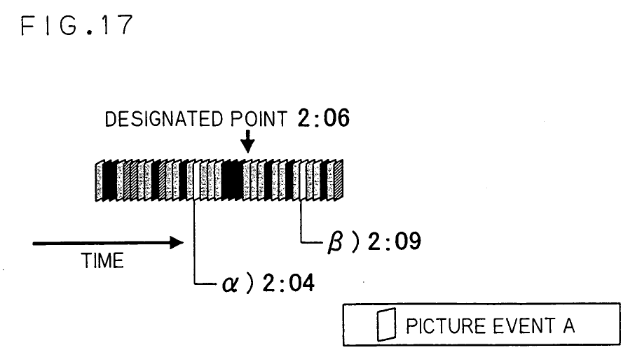

FIG. 17 shows an example of audio and video data containing a retrieval key. The detailed processing of the variation point detector 33 will be described by using a case where the video data shown in FIG. 17 are achieved by the key picture achieving unit 12.

There may be considered various methods for detecting variation points. This embodiment uses a method of pre-defining picture events serving as visual breakpoints and detecting as a variation point a time at which the defined picture event appears from the video data.

(2-1-1) General Processing

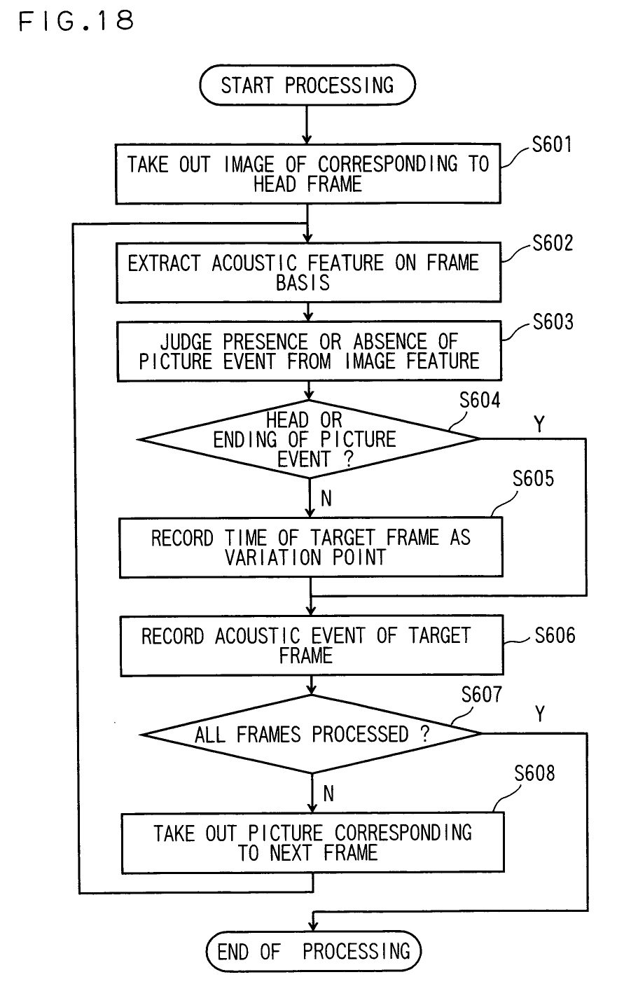

FIG. 18 is a processing flowchart of the variation point detector 33 of this embodiment.

First, in step S601, video data corresponding to the head frame section of a retrieval key are achieved. Here, a frame represents a detection section having a fixed time width, and it has a concept different from a so-called frame as a still image.

Subsequently, in step S602, image feature parameters are extracted from the video data extracted in step S601.

In step S603, it is judged by using the extracted image feature parameters whether the pre-defined picture event occurs in the section corresponding to the frame. As a judgment criterion, for example, if there is a picture event whose distance from each model learned in advance is within a threshold value, it is judged that the event concerned occurs.

In step S604, a judgment as to the head or ending of the picture event in the target frame is made. If the judgment is satisfied, the processing goes to step S605. With respect to the head frame, no visual even occurs and thus the processing goes to step S606.

In step S606, the picture event judged in step S603 is recorded. In this case, no visual even is detected and thus nothing is recorded.

Subsequently, the ending judgment is carried out in step S607. In this case, the processing on all the frames has not yet been completed, and thus the processing goes to step S608 to take out the video data corresponding to the next frame section.

(2-1-2) Specific Processing

There is considered a case where a frame (that is, video data) containing α) 2:04 of FIG. 17 is processed after the same processing is repeated. Here, it is assumed that no picture event is detected in the immediately preceding frame.

In step S602, image feature parameters of the target frame are extracted.

Subsequently, in step S603, it is judged whether the image feature parameters are with in a threshold value of the model of each picture event, and it is judged that a picture event A occurs in the target frame. Since no event occurs in the immediately preceding frame in the judgment carried out in step S604, it is judged that this is the starting point of the picture event, and the processing goes to step S605.

In step S605, the judgment result that the time a) 2:04 is a variation point is recorded so that it is usable in the subsequent processing.

Subsequently, the picture event A detected in the present target frame is recorded in step S606, and then the processing goes to the ending judgment of step S607.

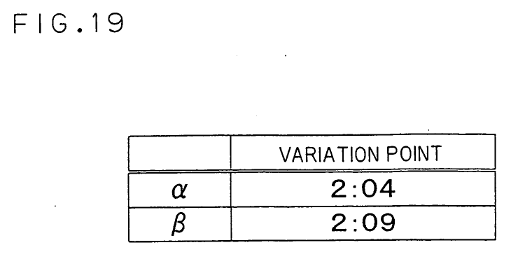

When the same processing is carried out on all the key video data, the ending judgment is carried out in step S607, a list of variation points as shown in FIG. 19 is output and then the processing of the variation point detector 33 is finished.

In the foregoing description, the picture event is detected and set as a variation point. However, various methods using pictures such as a cut detecting method which has been hitherto used frequently, a method of detecting a variation point in accordance with the presence or absence of telop, etc. may be used.

By the above construction, the user can designate a retrieval key for audio and video data with a very simple operation. Furthermore, the retrieval key corresponds to a section that is visually cohesive, and thus for example, in a program in which predetermined pictures are constructively inserted, visual/acoustic sections which are repetitively broadcasted can be accurately detected, so that the high-precision acoustic retrieval can be implemented.

### Sixth Embodiment

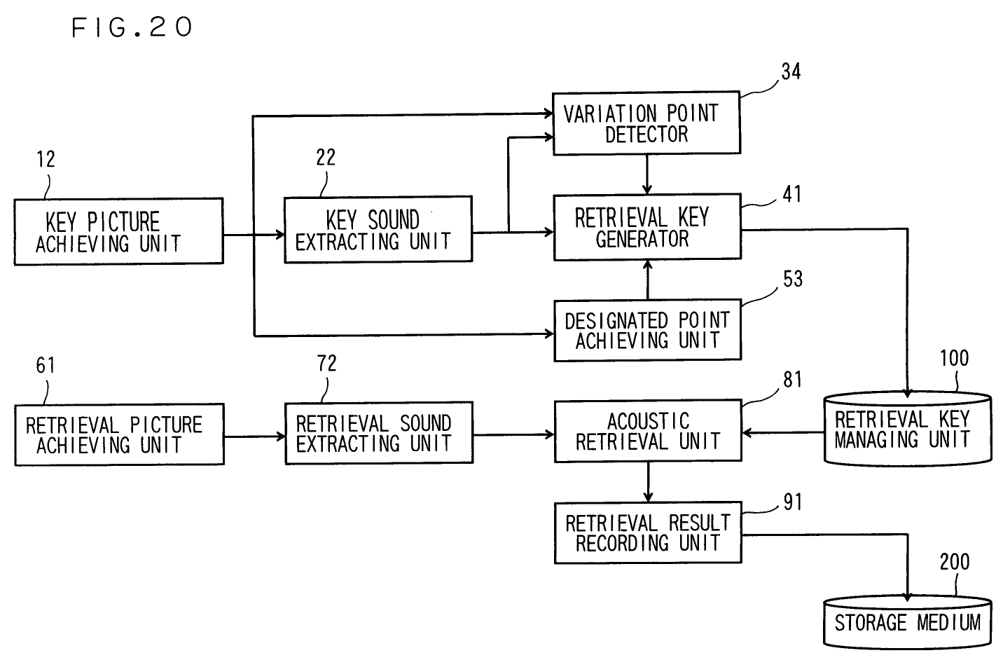

Next, a sixth embodiment of the present invention will be described with reference to FIGS. 20 to 22.

(1) Construction of Audio and Video Processing Device

FIG. 20 is a diagram showing the construction of the audio and video processing device according to the sixth embodiment.

As shown in FIG. 20, the audio and video processing device of this embodiment comprises a key picture achieving unit 12, a key sound extracting unit 22, a variation point detector 34, a retrieval key generator 41, a designated point achieving unit 53, a retrieval picture achieving unit 61, a retrieval sound extracting unit 72, an acoustic retrieval unit 81, a retrieval result recording unit 91, a retrieval key managing unit 100 and a recording medium 200. In FIG. 20, the elements for carrying out the same processing as the above-described embodiments are represented by the same reference numeral, and the description thereof is omitted. This embodiment is greatly different from the above-described embodiments in that variation points are detected from video data and audio data in the variation point detector 34.

The key picture achieving unit 12 achieves audio and video data from an external digital video camera, a reception tuber of digital broadcast or the like or other digital equipment and delivers the digital audio and video data to the key sound extracting unit 22, the variation point detector 34 and the designated point achieving unit 53. The key picture achieving unit 12 may achieve audio and video data from the external video camera, a broadcast reception tuner or other equipment, convert the audio and video data thus achieved to digital audio and video data and then deliver the digital audio and video data to the key sound extracting unit 22, the variation point detector 34 or the designated point achieving unit 53. Alternatively, the digital audio and video data may be recorded in the recording medium so that the key sound extracting unit 22, the variation point detector 34 and the designated point achieving unit 53 can read the digital audio and video data from the recording medium 200. In addition to these processing, the audio and video data may be subjected to decipher processing (for example, B-CAS), decode processing (for example, MPEG2), format conversion processing (for example, TS/PS), rate (compression rate) conversion processing or the like as needed.

The key sound extracting unit 22 extracts the audio data from the audio and video data achieved in the key picture achieving unit 12, and delivers the audio data to the retrieval key generator 41 and the variation point detector 34.

The variation point detector 34 extracts respective feature parameters from the audio and video data achieved in the key picture achieving unit 12 and the key sound extracting unit 22, and detects as a variation point a time at which a visual variation and an acoustic variation appear. The variation point thus detected is delivered to the retrieval key generator 41 as information such as a time or the like with which an access to the audio and video data is possible. The detailed processing of the variation point detector 34 will be described later.

(2) Processing of Audio and Video Processing Device

Next, the detailed processing of the audio and video processing device according to the sixth embodiment will be described.

(2-1) Processing of Variation Point Detector 34

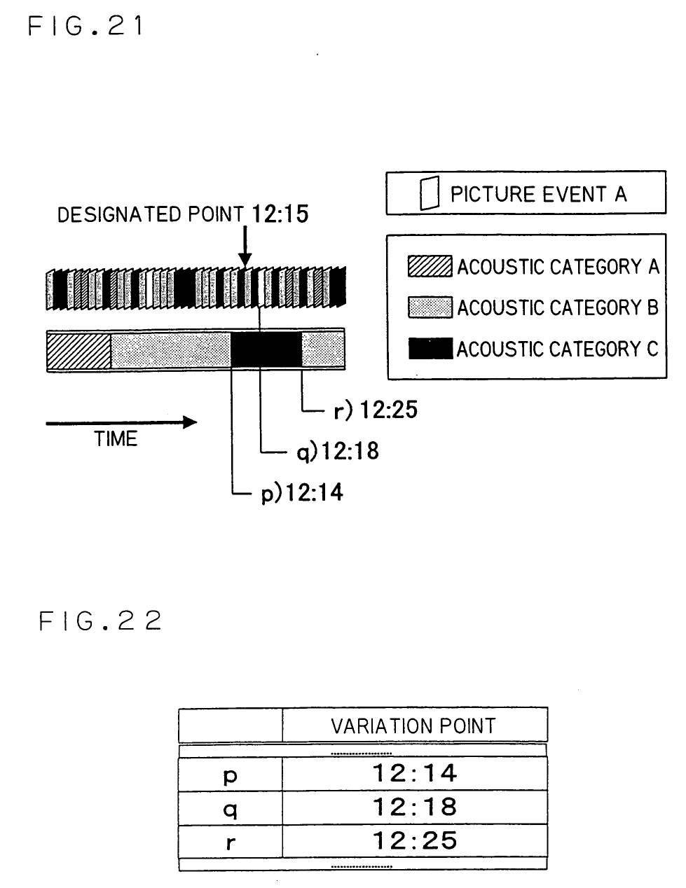

FIG. 21 shows an example of audio and video data containing a retrieval key. The detailed processing of the variation point detector 34 will be described by using a case where pictures and sounds shown in FIG. 21 are achieved by the key picture achieving unit 12.

Various methods for detecting variation points may be considered, however, this embodiment uses a method of detecting variation points of acoustic categories according to the processing flowchart of FIG. 3 from audio data and detecting picture events according to the processing flowchart of FIG. 18 from video data.

(2-1-1) Processing on Audio Data

First, the processing on audio data will be described.

In step S101, the sound corresponding to the head frame section of the retrieval key is achieved.

Subsequently, in step S102, acoustic feature parameters are extracted from the frame audio data extracted in step S101.

In step S103, it is judged by using the extracted acoustic feature parameters to which acoustic category each frame belongs. The head frame is judged as belonging to the acoustic category A.

Subsequently, in step S104, there is no immediately preceding frame, and thus the processing goes to step S106 as in the case where coincidence is judged.

In step S106, the acoustic category judged in step S103 is recorded. In this case, the acoustic category A is recorded.

Subsequently, in step S107, the ending judgment is carried out. In this case, all the frames have not yet been processed, and thus the processing goes to step S108 to take out audio data corresponding to the next frame section.

Here is considered a case where the frame of p) 12:14 of FIG. 21 is processed after the same processing is repeated. Here, the immediately preceding frame is assumed to belong to the acoustic category B.

In step S102, the acoustic feature parameters of the target frame are extracted, and in step S103 the target frame is classified into the acoustic category C on the basis of the calculation of the distance from each model. Through the comparison with the immediately preceding frame in the judgment of step S104, the acoustic categories B and C are different from each other, and thus it is judged that a variation point is detected, so that the processing goes to step S105.

In step S105, the judgment result that the time p) 12:14 is a variation point is recorded in step S105 so that the subsequent processing can use the judgment result.

Subsequently, the acoustic category C to which the present target frame belongs is recorded in step S106, and then the processing goes to the ending judgment of step S107.

The same processing is carried out on all the key audio data, and P) 12:14, r) 12:25, etc. are detected as variation points of the sounds.

(2-1-2) Processing on Video Data

Next, the processing on video data will be described.

First, in step S601, the video data corresponding to the head frame section of the retrieval key are achieved. Here, the frame represents a detected section having a fixed time width, and it is a concept different from a so-called frame as a still image.

Subsequently, in step S602, image feature parameters are extracted from the video data extracted in step S601.

In step S603, it is judged by using the extracted image feature parameters whether a pre-defined picture event occurs in the section corresponding to the frame.

In step S604, a judgment as to the head or ending of the picture event in the target frame is made. If the judgment is satisfied, the processing goes to step S605. With respect to the head frame, no picture event occurs, and thus the processing goes to S606.

In step S606, the picture event judged in step S603 is recorded. In this case, no picture event is detected, and thus nothing is recorded.

Subsequently, in step S607, the ending judgment is carried out. In this case, the processing has not yet been completed on all the frames, and thus the processing goes to step S608 to take out the video data corresponding to the next frame section.

Here is considered a case where the frame containing q)12:18 of FIG. 21 is processed after the same processing is repeated. Here, no picture event is detected in the immediately preceding frame.

In step S602, image feature parameters of the target frame are extracted.

Subsequently, in step S603, it is judged whether the image feature parameter is contained within a threshold value of the model of each picture event, and it is judged whether a picture event a occurs in the target frame. Since no event occurs in the immediately preceding frame in the judgment of the step S604, the starting point of the picture event is judged, and the processing goes to step S605.

In step S605, the judgment result that the time q)12:18 is a variation point is recorded so that the subsequent processing can use the judgment result concerned.

Subsequently, the picture event a detected in the present target frame is recorded in step S606, and then the processing goes to the ending judgment of step S607.

The same processing is carried out on all the key video data, and then the processing is finished.

Through the above processing, a list of variation points as shown in FIG. 22 is output, and the processing of the variation point detector 34 is finished.

In this embodiment, variation points are detected from the audio data and also variation points are detected from the video data, and all the variation points detected from each of the audio data and the video data are delivered to the retrieving key generator 41 as variation points. However, only the variation points that are detected from both the audio and video data may be delivered to the retrieving key generator 41, or an algorithm for detecting variation points from both the acoustic feature parameters and the image feature parameters may be used. That is, various methods may be considered.

With the above construction, the user can designate the retrieving key for the audio and video data with a very simple operation, and further the retrieving key is adapted to the section sandwiched between the visual or acoustic breakpoints, so that high-precision acoustic retrieval can be implemented on visual and acoustic contents having various constructions.

### Seventh Embodiment

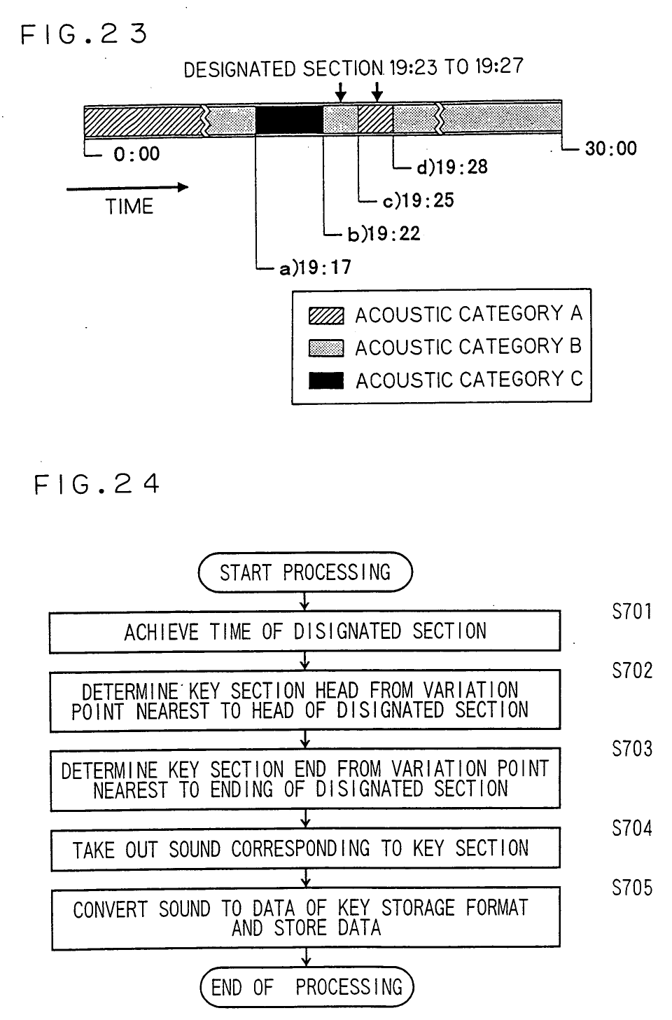

Next, a seventh embodiment of the invention will be described with reference to FIGS. 23, 24 and 26.

(1) Feature of Acoustic Processing Device

The construction of the acoustic processing device of the seventh embodiment is the same as the first embodiment, however, is different from the first embodiment in that plural designated points are achieved from a user in the designated point achieving unit 51 and the retrieval key generator 41 determines the section of a retrieval key from plural designated points and variation points.

This is adapted to a case where the user designates the head and the ending of a section which the user wants to register as a retrieval key. It is a cumbersome work to separately designate two places corresponding to the head and the ending. However, by setting the time period from a push starting time of a register button for a retrieval key to a button releasing time as the section of the retrieval key, a key section can be designated with a simple operation which is not so different from an operation of designating one point.

At this time, it is difficult for the user to accurately designate the section, however, by correcting the section in consideration of the variation points, etc. achieved in the variation point detector 31, the retrieval key section for which accurate acoustic retrieval can be performed can be determined. In this embodiment, is considered a case where an inaccurate section designated by a user is corrected and a high-precision retrieval key is registered.

(2) Specific Processing

A specific example of the detailed processing of this embodiment will be described.

FIG. 23 shows an example of audio data containing a retrieval key. The processing result of the variation point detector 31 to the audio data of FIG. 23 corresponds to a variation point list shown in FIG. 5.

Here, the detailed processing of the retrieval key generator 41 will be described by using a case where the list of the variation points is shown in FIG. 5.

FIG. 24 is a processing flowchart of the retrieval key generator 41 of this embodiment.

First, in step S701, plural designated points achieved by the designated point achieving unit are achieved. In this case, as shown in FIG. 23, 19:23 and 19:27 are achieved as times designated by a user.

Subsequently, in step S702, a variation point nearest to the head of the designated section, that is, 19:23 is searched from a variation point list to determine the head of the key section. In this case, b) 19:22 corresponding to the starting point of the acoustic event B serves as the head. Furthermore, in step S703, a variation point nearest to the ending of the designated section, that is, 19:27 is searched from the variation point list to determine the ending of the key section. In this case, d) 19:28 which is the ending time of the acoustic category A is the ending of the key section. Through the above operation, a time area of six seconds surrounded by (b) and (d) is judged as the section of the retrieval key, and the portion corresponding to the key section is taken out from the audio data achieved in the key sound achieving unit 21 in step S704, converted to data of a format needed for acoustic retrieval in step S705 and then delivered to the retrieval key managing unit 100. Then, the processing is finished.

According to this embodiment, peripheral variation points are found out from plural designated points achieved from the user, that is, section information, and the section is corrected on the basis of the variation point, whereby plural acoustic categories are registered as a set in a retrieval key, that is, a retrieval key section which has high flexibility and perform accurate acoustic retrieval can be determined. In this embodiment, the audio data are targeted. However, the present invention is applicable to the other embodiments targeting audio and video data.

Furthermore, this embodiment uses the method of determining the key section from the variation point nearest to the designated section. However, any method may be used insofar as the key section can be determined on the basis of the designated points and the variation points. For example, there may be considered various methods such as a method of determining a key section on the basis of only variation points located at the inside or outside of the designated section, a method of determining a key section on the basis of a variation point before each designated point on the assumption of delay of an operation.

When a key section is determined on the basis of variation points located inside the designated section from the audio data shown in FIG. 26, c) 19:25 subsequent to the designated starting end 19:24 becomes the start point of the key section, and d) 19:28 before the designated terminating end 19:29 becomes the terminal point of the key section. As described above, various association rules are prepared between the designated section achieved through user's operation and the actually extracted key section, whereby various key registrations adapted to user's operation can be performed.

What is claimed is:

1. An information processing device for retrieving retrieval target audio data or retrieval target audio and video data to be retrieved by a retrieval key comprising:
a key audio and video achieving processor unit for achieving key audio and video data for extracting the retrieval key;
a key sound extracting processor unit for extracting key audio data from the key audio and video data;
an image variation point detecting processor unit for converting image data in the key audio and video data to an image feature parameter and detecting as a variation point a time at which variation of the image feature parameter thus converted appears; and
a retrieval key generating processor unit for determining a retrieval key section on the basis of at least one variation point and generating a retrieval key on the basis of the portion corresponding to the retrieval key section in the key audio data.

2. An information processing device for retrieving retrieval target audio data or retrieval target audio and video data to be retrieved by a retrieval key comprising:
a key sound achieving processor unit for achieving key audio data for extracting the retrieval key;
an acoustic variation point detecting processor unit for converting the key audio data to an acoustic feature parameter and detecting as a variation point a time at which variation of the acoustic feature parameter thus converted appears; and
a retrieval key generating processor unit for determining a retrieval key section on the basis of at least one variation point and generating a retrieval key on the basis of the portion corresponding to the retrieval key section in the key audio data.

3. An information processing device for retrieving retrieval target audio data or retrieval target audio and video data to be retrieved by a retrieval key comprising:
a key audio and video achieving processor unit for achieving key audio and video data for extracting the retrieval key;
a key sound extracting processor unit for extracting key audio data from the key audio and video data;
an acoustic variation point detecting processor unit for converting the key audio data to an acoustic feature parameter and detecting as a variation point a time at which variation of the acoustic feature parameter thus converted appears;
an image variation point detecting processor unit for converting image data in the key audio and video data to an image feature parameter and detecting as a variation point a time at which variation of the image feature parameter thus converted appears; and
a retrieval key generating processor unit for determining a retrieval key section on the basis of at least one sound-based variation point or image-based variation point and generating a retrieval key on the basis of the portion corresponding to the retrieval key section in the key audio data.

4. The information processing device according to claim 2, wherein the key sound achieving processor unit achieves key audio data from audio and video data for extracting the retrieval key.

5. The information processing device according to any one of claims 1 to 3, further comprising a designated point achieving processor unit for achieving one or plural designated points while a time for designating the whole or a part of a section of the key audio data or the audio and video data is set as a designated point, wherein the retrieval key generating processor unit determines a retrieval key section on the basis of at least one of the variation point and the designated point.

6. The information processing device according to claim 2 or 3, wherein the acoustic variation point detecting processor unit divides the key audio data into detection section units each having a predetermined time width, converts the key audio data divided into the detection section units to acoustic feature parameters, classifies the detection sections into any one of plural pre-defined acoustic categories, and detects as a variation point a detection section whose classified acoustic category is different from the classified acoustic categories of detection sections before and after the detection section concerned.

7. The information processing device according to claim 2 or 3, wherein the acoustic variation point detecting processor unit divides the key audio data into detection section units, converts the audio data divided into the detection section units to acoustic feature parameters, and detects whether pre-defined one or plural acoustic events occur or not in the detection section, and detects as a variation point a detection section in which the acoustic event occurs.

8. The information processing device according to any one of claims 1 to 3, wherein the retrieval key contains audio data of the portion corresponding to the retrieval key section in the key audio data.

9. The information processing device according to any one of claims 1 to 3, the retrieval key contains acoustic feature parameters extracted from the portion corresponding to the retrieval key section in the key audio data.

10. The information processing device according to any one of claims 1 to 3, wherein the retrieval key contains key sound identifying information for identifying the key audio data.

11. A sound retrieving device for the information processing device according to any one of claims 1 to 3, comprising:
a retrieval sound achieving processor unit for achieving the retrieval audio data; and
an acoustic retrieval processor unit for comparing the retrieval key generated with the retrieval audio data and achieving a retrieval result representing a portion of the retrieval audio data that satisfies a predetermined condition.

12. The sound retrieving device according to claim 11, wherein the retrieval sound achieving processor unit achieves the retrieval audio data from the retrieval audio and video data.

13. An information processing method for retrieving retrieval target audio data or retrieval target audio and video data to be retrieved by a retrieval key comprising:
achieving key audio and video data for extracting the retrieval key;
extracting key audio data from the key audio and video data;
converting image data in the key audio and video data to an image feature parameter and detecting as a variation point a time at which variation of the image feature parameter thus converted appears; and
determining a retrieval key section on the basis of at least one variation point and generating a retrieval key on the basis of the portion corresponding to the retrieval key section in the key audio data.

14. An information processing method for retrieving retrieval target audio data or retrieval target audio and video data to be retrieved by a retrieval key comprising:
achieving key audio data for extracting the retrieval key;
converting the key audio data to an acoustic feature parameter and detecting as a variation point a time at which variation of the acoustic feature parameter thus converted appears; and
determining a retrieval key section on the basis of at least one variation point and generating a retrieval key on the basis of the portion corresponding to the retrieval key section in the key audio data.

15. An information processing method for retrieving retrieval target audio data or retrieval target audio and video data to be retrieved by a retrieval key comprising:
achieving key audio and video data for extracting the retrieval key;
extracting key audio data from the key audio and video data;
converting the key audio data to an acoustic feature parameter and detecting as a variation point a time at which variation of the acoustic feature parameter thus converted appears;
converting image data in the key audio and video data to an image feature parameter and detecting as a variation point a time at which variation of the image feature parameter thus converted appears; and
determining a retrieval key section on the basis of at least one sound-based variation point or image-based variation point and generating a retrieval key on the basis of the portion corresponding to the retrieval key section in the key audio data.

16. An information processing program product for making a computer implement an information processing method for retrieving retrieval target audio data or retrieval target audio and video data to be retrieved by a retrieval key, the program product comprising the instructions of:
achieving key audio and video data for extracting the retrieval key;
extracting key audio data from the key audio and video data;
converting image data in the key audio and video data to an image feature parameter and detecting as a variation point a time at which variation of the image feature parameter thus converted appears; and
determining a retrieval key section on the basis of at least one variation point and generating a retrieval key on the basis of the portion corresponding to the retrieval key section in the key audio data.

17. An information processing program product for making a computer implement an information processing method for retrieving retrieval target audio data or retrieval target audio and video data to be retrieved by a retrieval key, the program product comprising the instructions of:
achieving key audio data for extracting the retrieval key;
converting the key audio data to an acoustic feature parameter and detecting as a variation point a time at which variation of the acoustic feature parameter thus converted appears; and
determining a retrieval key section on the basis of at least one variation point and generating a retrieval key on the basis of the portion corresponding to the retrieval key section in the key audio data.

18. An information processing program product for making a computer implement an information processing method for retrieving retrieval target audio data or retrieval target audio and video data to be retrieved by a retrieval key, the program product comprising the instructions of:
achieving key audio and video data for extracting the retrieval key;
extracting key audio data from the key audio and video data;
converting the key audio data to an acoustic feature parameter and detecting as a variation point a time at which variation of the acoustic feature parameter thus converted appears;
converting image data in the key audio and video data to an image feature parameter and detecting as a variation point a time at which variation of the image feature parameter thus converted appears; and
determining a retrieval key section on the basis of at least one sound-based variation point or image-based variation point and generating a retrieval key on the basis of the portion corresponding to the retrieval key section in the key audio data.
